(19) United States
(12) Patent Application Publication
(10) Pub. No.: US 2009/0128494 A1
(43) Pub. Date: May 21, 2009

(54) Computerized phone book

(76) Inventor: Duane Cherry, Live Oak, FL (US)

Correspondence Address: THE INVENTORS NETWORK, INC., 332 ACADEMY STREET, CARNEGIE, PA, 15106, US

(21) Appl. No.: 11/985,748

(22) Filed: Nov. 19, 2007

(51) Int. Cl. G06F 3/02; G06F 1/16; G06F 7/00

(52) U.S. Cl. 345/169; 707/104.1; 707/E17.001

(57) ABSTRACT

A handy, lightweight computerized phone book includes a main memory partitioned into various compartments for storage of residential phone numbers and business phone numbers that are inputted manually or from a disc whereupon the numbers and addresses whereupon the numbers and addresses are segregated by number, business address, emergency numbers, and frequent/favorite numbers all of which are quickly accessible by the user manually pressing one or more buttons located on the face and which include a resident button, a business button, an emergency button, a list button, a disc button and a help button and then following simple and minimal screen promptings to retrieve the desired number and/or business address.

### FIELD OF THE INVENTION

The present invention pertains to electronic methods and apparatus for the storage and retrieval of digitally stored phone numbers, and more particularly pertains to a computerized phone book having digitally stored phone numbers accessible through various parameters.

### BACKGROUND OF THE INVENTION

Digital storage and retrieval of information is common in today's society. Whether the information is stored in the form of thousands of songs on a music playing device or favorite songs recorded on a personal cd, it is the easy access and retrieval of the information that is the paramount benefit. Among the most common types of information stored on electronic devices (cell phones, pda's) are telephone numbers. The telephone numbers can range from personal and business numbers to emergency numbers and frequently called numbers. However, only a limited number of telephone numbers can be stored, and access is usually attained through a sequential scrolling through a limited directory. Moreover, it is often the case that the individual needs to find a telephone number that is not stored in his/her limited directory, but the individual is not handy to or located near a complete telephone book. The individual may also not be near a wireless Internet site that would provide access to telephone numbers via an Internet site such as AOL or an Internet search engine such as Google. Therefore, it would be highly desirable to have a preferably portable and hand-held device having a large number of telephone numbers (ranging across categories such as residential, commercial, business, government and private) stored within the device and easily accessible through a minimum of screen commands and promptings. Thus, the prior art discloses a number of systems and devices for receiving, storing, and retrieving upon request information such as telephone numbers.

For example, the Gelfer et al. patent (U.S. Pat. No. 6,136,596) discloses a phonebook that includes a database constructed by the user' input and a user voice actuated search engine.

The Mugura et al. patent (U.S. Pat. No. 6,222,921 B1) discloses a method and apparatus for displaying an electronic phonebook that includes a main menu for displaying primary information and a secondary menu for displaying a name associated with the information displayed at the primary level.

The Guerlin patent (U.S. Pat. No. 6,259,934 B1) discloses a radio communication device programmed to receive and store data from a radio communication.

The Chmaytelli et al. patent (U.S. Pat. No. 6,418,311 B1) discloses a handset phonebook having search and replace features for receiving data packets from cell sites and automatically updating the phone book.

The Mitsuoka et al. patent (U.S. Pat. No. 6,671,508 B1) discloses a mobile communication terminal having various services that can be accessed and transmitted between a sender and a recipient.

The Saarinen et al. patent (U.S. Pat. No. 6,697,483 B1) discloses a method for searching an electronic phonebook of a cellular phone wherein searching is conducted by matching one or more templates to given alphanumeric strings.

Nonetheless, despite the ingenuity of the above devices, there remains a need for a computerized phone book that can easily and quickly retrieve personal names and business addresses and phone numbers with little or no directory searching or scrolling.

### SUMMARY OF THE INVENTION

The present invention comprehends a computerized phone book that allows the user to quickly and easily access and retrieve phone numbers and addresses by various designations or categories. The computerized phone book allows the user to input phone numbers and addresses manually by initiating and then following display screen prompts or by inserting a disc for inputting and updating address and phone number information.

A number of buttons are mounted on the case or housing of the computerized phone book, and are interconnected to a cpu for accessing and retrieving phone numbers or addresses. The primary buttons include a resident button for retrieving residential phone numbers, a business button for retrieving commercial and business phone numbers, an emergency button for retrieving emergency phone numbers (fire, police, paramedic, medical, etc.), and a favorite/frequent button for retrieving frequently used numbers or favorite numbers (family members, relatives, friends, etc.).

In addition, other buttons include a disc button that permits the user to access the disc drive for inputting and updating information to the phone book (main memory storage), a help button that provides step-by-step instructions for the various functions of the computerized phone book, a clear button for clearing the screen and a light button for lighting the LCD screen thereby providing the user with day and night use for the computerized phone book.

It is an objective of the present invention to provide a computerized phone book that is convenient, handy, and lightweight.

It is another objective of the present invention to provide a computerized phone book that enables the user to quickly and easily access any telephone number or address anywhere in the United States.

It is yet another objective of the present invention to provide a computerized phone book that is adaptable for both personal and business use.

It is still yet another objective of the present invention to provide a computerized phone book that can be updated as needed with the most recent, up-to-date information as needed.

These and other objects, features, and advantages will become apparent to those skilled in the art upon a perusal of the following detailed description read in conjunction with the accompanying drawing figures and appended claims.

### BRIEF DESCRIPTION OF THE DRAWINGS

FIG. 1 is a perspective view of the computerized phone book of the present invention;

FIG. 2 is a top plan view of the computerized phone book of the present invention illustrating a cd disc for inputting and updating information to the computerized phone book;

FIG. 3 is a front elevational view of the computerized phone book of the present invention illustrating a representative initial screen display following pressing of the resident button on the computerized phone book;

FIG. 4 is a front elevational view of the computerized phone book of the present invention illustrating a second screen display following pressing of the resident button on the computerized phone book;

FIG. 5 is a front elevational view of the computerized phone book of the present invention illustrating the display of the requested phone resulting from the entries shown in FIGS. 3 and 4 on the display of the computerized phone book;

FIG. 6 is a front elevational view of the computerized phone book of the present invention illustrating a representative initial screen display upon the user pressing the business button on the computerized phone book;

FIG. 7 is a front elevational view of the computerized phone book of the present invention illustrating a second screen display following the screen display first shown in FIG. 6;

FIG. 8 is a front elevational view of the computerized phone book of the present invention illustrating the display of the requested business phone number resulting from the entries shown in FIGS. 6 and 7 on the display of the computerized phone book;

FIG. 9 is a front elevational view of the computerized phone book of the present invention illustrating a representative screen display resulting from the pressing of the emergency button of the computerized phone book;

FIG. 10 is a front elevational view of the computerized phone book of the present invention illustrating a representative screen display resulting from the pressing of the list button of the computerized phone book;

FIG. 11 is a block diagram of the computerized phone book of the present invention illustrating some of the components of the computerized phone book;

FIG. 12 is a representative flowchart for the computerized phone book of the present invention illustrating the sequence of steps that occur when certain of the buttons of the computerized phone book are engaged; and

FIG. 13 is a representative flowchart for the computerized phone book of the present invention illustrating the sequence of steps that occur for inputting information to the computerized phone book.

### DETAILED DESCRIPTION OF THE PREFERRED EMBODIMENT

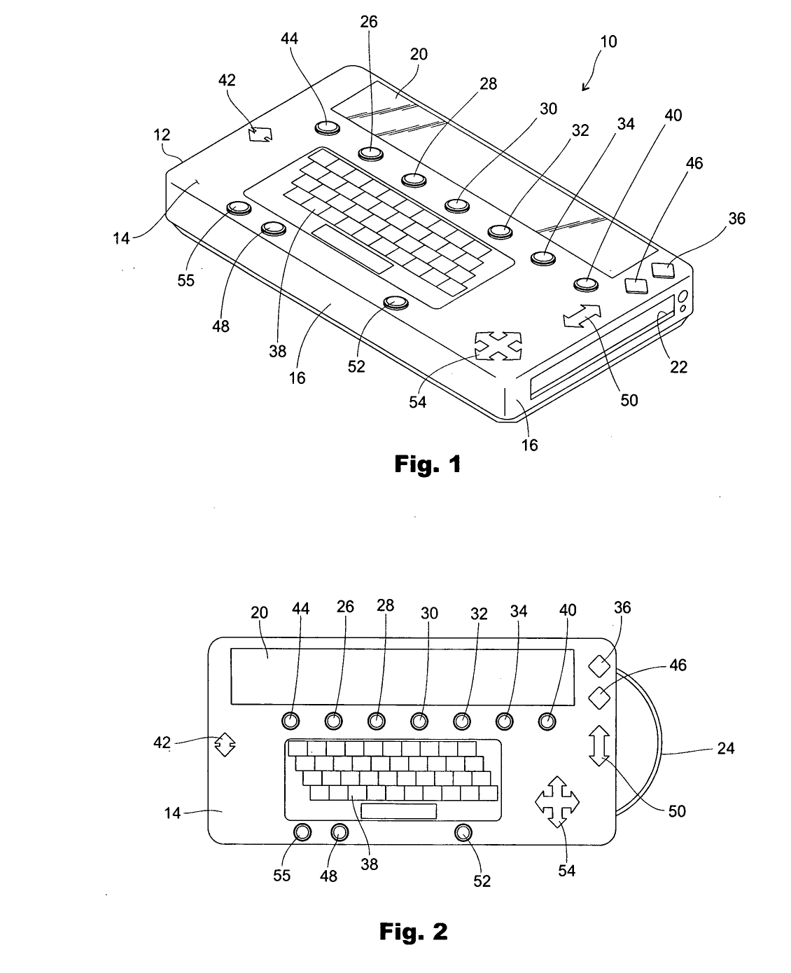

Illustrated in FIGS. 1-13 is a computerized phone book 10 that stores telephone numbers divided or segregated by or into various categories such as residential phone numbers, business phone numbers, frequently called or favorite phone numbers or emergency phone numbers. The computerized phone book 10 is lightweight, portable, handy and easy to use by both adults and children for looking up and retrieving phone numbers stored in main memory storage.

Thus, shown in FIGS. 1 and 2 is the computerized phone book 10 that includes a rectangular-shaped casing or housing 12 having a front panel surface 14 and surrounding side panel surfaces 16. Located on the front panel surface 18 is an LCD screen 20 and a number of other function buttons for initiating and operating all the functions of the computerized phone book 10. In addition, located on one side panel surface 16 is a disc drive slot 22 into which a cd disc 24 (and in the alternative a DVD disc) can be inserted for reading and inputting information therefrom in the form of nationwide phone numbers—arranged alphabetically by state—to keep the computerized phone book 10 up-to-date.

Among the manually operable buttons located on the front panel surface 14 are a resident button 26 for retrieving a residential phone number, a business button 28 for retrieving a selected business phone number, an emergency button 30 for entering and retrieving an emergency phone number, a list button 32 for entering, storing, and retrieving favorite and/or frequently-called phone numbers. A disc button 34 allows the user to access a disc 24 inserted into the disc slot 22 for updating the phone book 10 and a help button 36 can be pressed to guide the user through the various functions in a step-by-step process. For entering, adding, updating, and retrieving phone numbers a standard qwerty keyboard 38 is centrally arranged on the front surface panel 14. A power on/off button 40 is located to one side of the LCD screen 20 while a light control button 42 is located on the opposite side of the LCD screen 20 for manually regulating the dimness and brightness of the LCD screen 20 (and lights the LCD screen 20 at night) so that the user can use the computerized phone book 10 at nighttime or in enclosed dark locations or areas.

As shown in FIGS. 1 and 2 the computerized phone book 10 includes a clear button 44 for clearing the LCD screen 20, a shift button 46 for shifting functions of the computerized phone book 10, a back button 48 to delete one space, a next button 50 to move or transfer to different screens or functions, an enter button 52 to enter information (updated residential and business phone numbers) to main memory, and a cursor button 54 that allows the user to move the cursor up and down and left and right and a capitalize button 55.

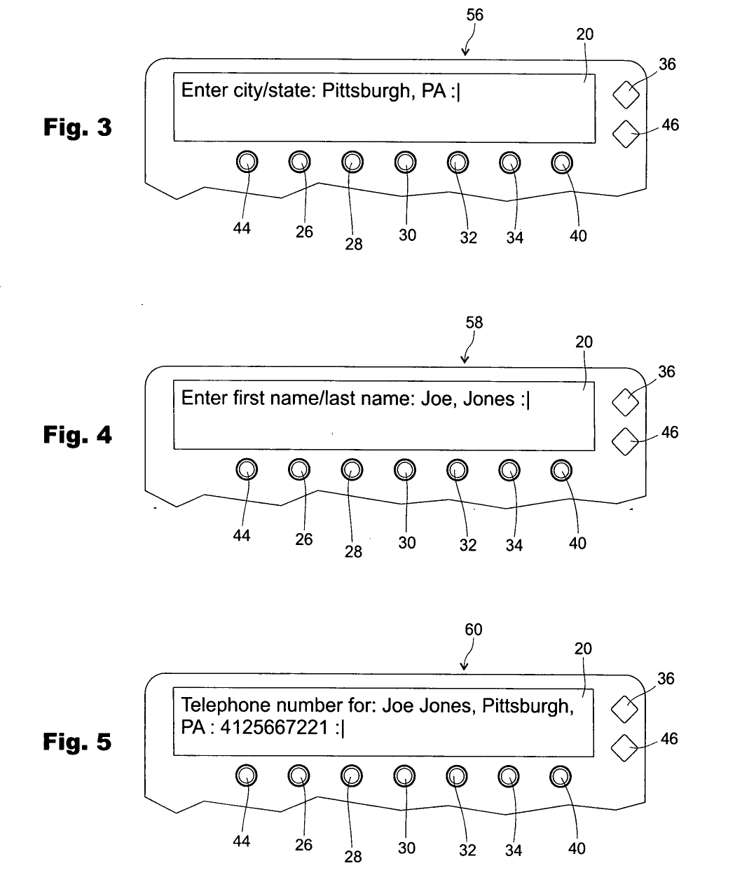

Illustrated in FIGS. 3-5 are representative screen displays that result when the user first pushes the resident button 26 to initiate the retrieval of a desired residential phone number. FIG. 3 shows an initial screen display 56 wherein the user has typed in the city and state “Pittsburgh, Pa.” to commence the search for the telephone number. The user then presses the enter button 52 to bring up the next (second) screen display 58 as shown in FIG. 4. The screen display 58 of FIG. 4 requests that the first name and last name of the individual whose phone number is to be retrieved should be entered. The user then presses the enter button 52 and the (third) screen display 60 shown in FIG. 5 comes up that lists the requested and retrieved phone number. As an additional check, the name of the individual and the city and state are shown on the screen display 60 along with the requested and retrieved telephone number.

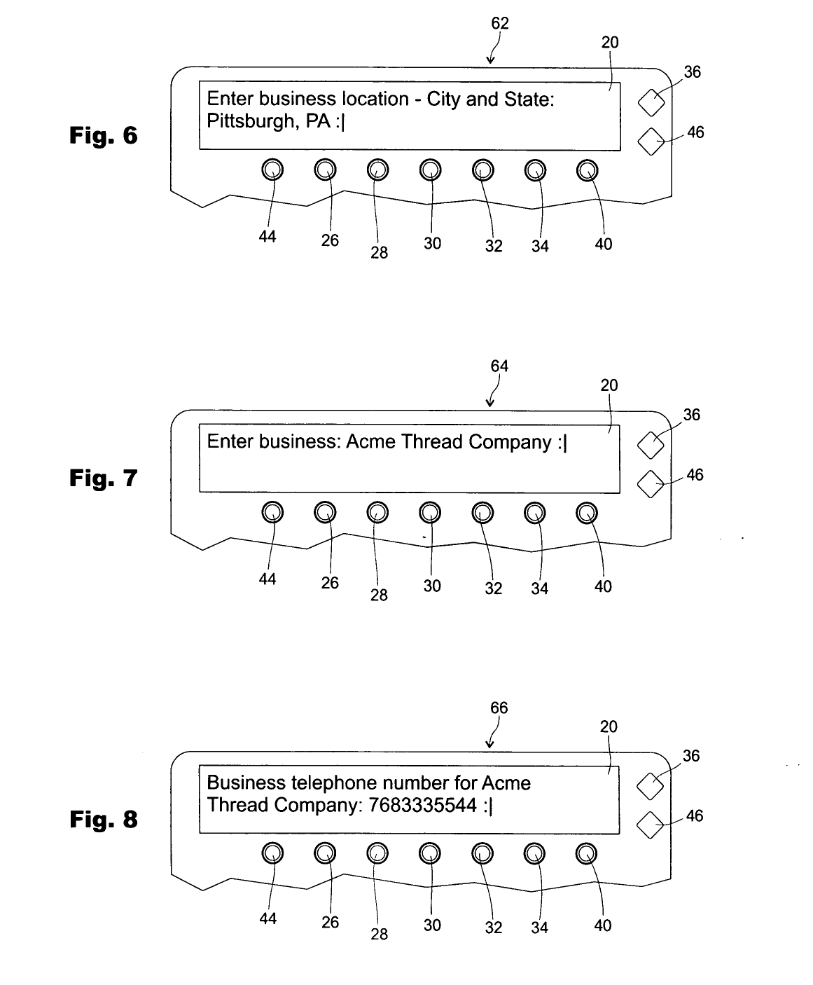

FIGS. 6-8 illustrate representative screen displays for retrieving a requested business phone number. Thus, FIG. 6 illustrates a (first) screen display 62 upon the user pressing the business button 28 and typing in the city and state. After the appropriate city and state “Pittsburgh, Pa.” appears, the user hits the enter button 52 thereby allowing the user to type in the name of the business: “Acme Thread” on the next screen. This screen (second screen) 64 is shown in FIG. 7. Finally, the user presses the enter button 52 and the requested business phone number appears, as shown in the screen display 66 of FIG. 8. In addition, the entries—city, state, and business name—from the prior screens 62 and 64 also appear as a means of verifying that the desired business in the right city and state was initially entered.

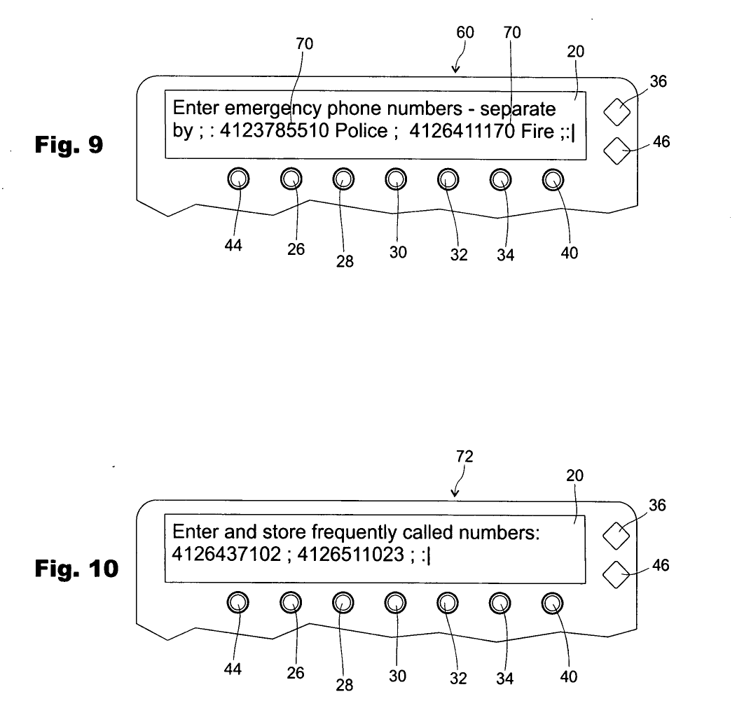

FIG. 9 illustrates a representative screen display 68 that results from pressing the emergency button 30. After pressing the emergency button 30 the user then presses the enter button 52 and the screen prompts appear requesting entry of the new or updated emergency phone numbers. Two representative emergency phone numbers 70 are shown being entered through the screen display 68 shown in FIG. 9.

FIG. 10 illustrates a representative screen display 72 that results from the user pressing the list button 32 to enter favorite and frequently called numbers. The screen display 72 of FIG. 10 shows the entry of two favorite/frequently numbers. A tag or marker such as a name or designation would be attached to and entered with each name to facilitate the retrieval of the numbers.

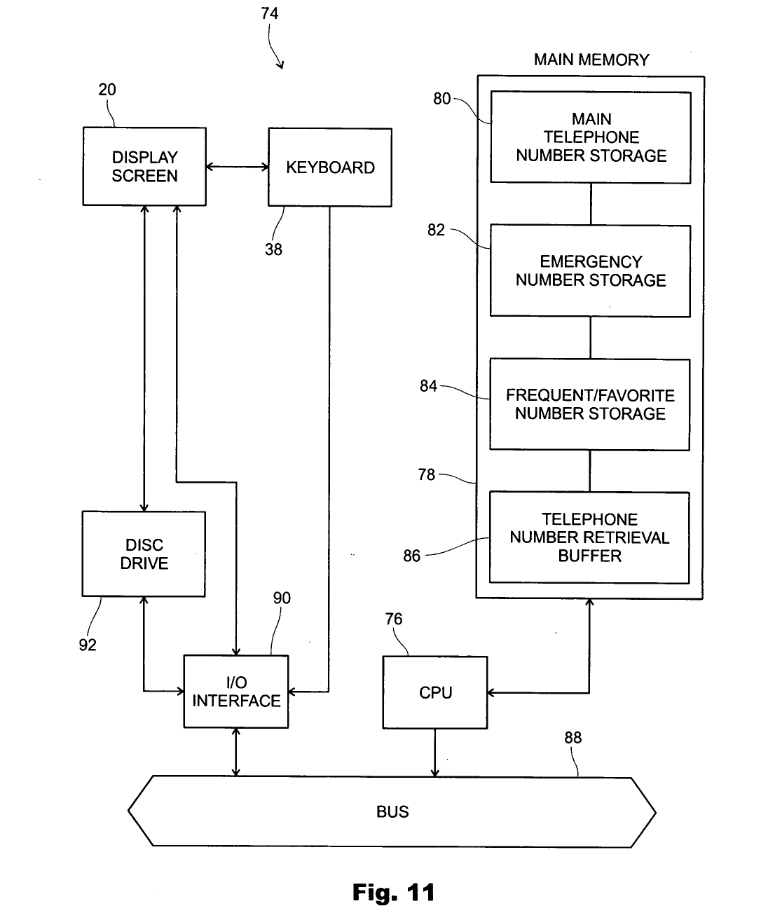

FIG. 11 illustrates a representative block diagram 74 of the basic electronic components of the computerized phone book 10 and their various interconnections, data communication and transfer pathways and routes. Thus, the computerized phone book 10 includes a cpu 76 interconnected to main memory storage 78. The main memory storage 78 is further segregated and subdivided into several subsidiary storage compartments. The subsidiary storage compartments include a main telephone number storage compartment 80 whereupon pressing the resident button 26 or the business button 28 initiates retrieval of the telephone numbers stored therein; an emergency number storage compartment 82 for storing any and all emergency phone numbers; a frequent/favorite telephone number storage compartment 84 for storage therein of all the frequently dialed and favorite telephone numbers; and a telephone number retrieval buffer 86 that serves as an intermediate and temporary storage area during data input, retrieval, and transfer.

A bus 88 is interconnected to the cpu 76 and serves to route, sequence, and organize signals, communications, and data transfer from and between main memory 78 and the cpu 76 and the other primary components: the I/O interface 90, the disc drive 92, the keyboard 38 and the LCD display screen 20. The disc drive 92 reads the information on the disc 24 loaded into the disc drive slot 22 so that the information can be transferred and stored to the main memory 78.

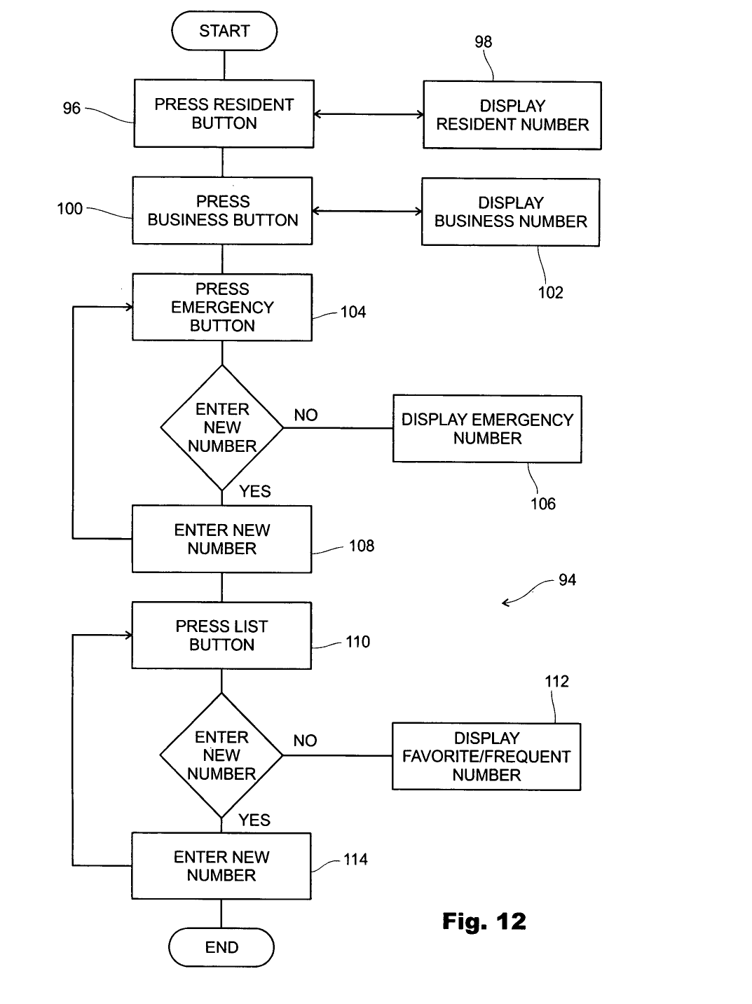

FIG. 12 is a representative flowchart 94 setting forth the basic operations or functions of the computerized phone book 10 upon the user pressing the resident button 96 to retrieve and display a desired resident phone number 98, pressing the business button 100 to retrieve and display a desired business phone number 102, pressing the emergency button 104 to either retrieve a desired emergency phone number 106 or enter a new emergency phone number 108, and pressing the list button 110 to retrieve and display a favorite/frequent phone number 112 or enter a new favorite/frequent phone number 114.

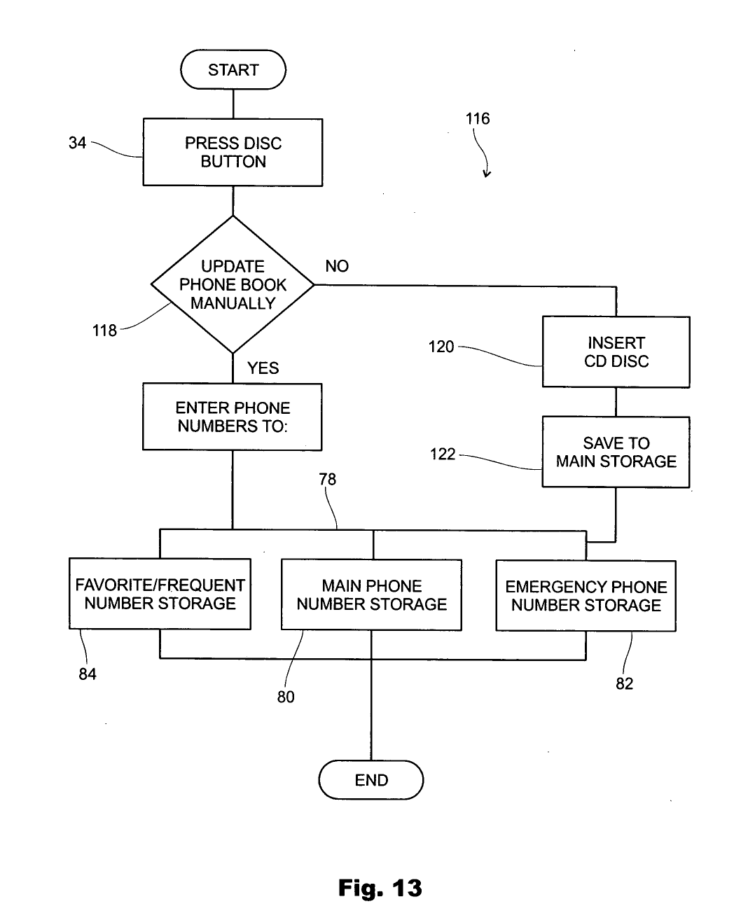

FIG. 13 illustrates a representative schematic or flowchart 116 illustrating the steps for inputting and updating information to the computerized phone book 10 by using the representative disc 24 containing the range of phone numbers to be added to the computerized phone book 10. As a first step the disc button 34 is pressed and then a screen display 118 would appear requesting disc update of the phone book either manually or from the disc 24. The user would enter “N” and then a screen display 120 would appear requesting insertion of the disc into the disc drive 92. After the insertion of the disc 24 into the disc drive 92, a screen display 122 would appear requesting “Save to main storage,” and the user would then press the enter button 52 thereby commencing the transfer and updating of the phone numbers to the main memory storage 78.

The foregoing detailed description is to be clearly understood as given by way of illustration and example only, and any modifications, alterations, and variations possible and practicable to those skilled in the art may be made while remaining within the spirit of the invention and the scope of the appended claims and their equivalents.

I claim:

1. A computerized phone book for entering, storing and retrieving telephone numbers, comprising:
a rectangular-shaped housing having a front panel surface;
an LCD screen located on the front panel surface;
a keyboard located on the front panel surface for entering, updating, and retrieving telephone numbers;
a resident button located on the front panel surface and which is pressed for retrieving a residential phone number;
a business button located on the front panel surface and which is pressed for retrieving a business phone number;
an emergency button located on the front panel surface and which is pressed for retrieving an emergency phone number;
a list button located on the front panel surface and which is pressed for retrieving a favorite telephone number and a frequently called telephone number;
a disc drive slot extending into the housing into which a disc can be inserted for updating the computerized phone book;
a disc drive contained within the housing and interconnected to the disc drive slot so that information can be transferred from the disc for updating the computerized phone book;
a cpu interconnected to and controlling the operations of the LCD screen, the keyboard, the resident button, the business button, the emergency button, the list button, and the disc drive; and
a main memory storage interconnected to the cpu for storage therein of the telephone numbers.

2. The computerized phone book of claim 1 wherein the main memory storage is partitioned into a main telephone number storage compartment, a frequent/favorite telephone storage compartment, and an emergency number storage compartment.

3. The computerized phone book of claim 2 further comprising a help button that is manually pressed to guide users through the operational functions of the computerized phone book.

4. The computerized phone book of claim 3 further comprising a light control button for lighting the LCD screen.

5. The computerized phone book of claim 4 further comprising a power on/off button for turning the computerized phone book on and off.

6. A computerized phone book for entering, storing, updating and retrieving telephone numbers, comprising:
a rectangular-shaped housing having a front panel surface;
an LCD display screen located on the front panel surface;
a keyboard located on the front panel surface for entering, storing, updating, and retrieving telephone numbers;
a resident button located on the front panel surface and which is pressed for retrieving residential phone numbers;
a business button located on the front panel surface and which is pressed for retrieving business phone numbers;
an emergency button located on the front panel surface and which is pressed for retrieving emergency phone numbers;
a list button located on the front panel surface and which is pressed for retrieving favorite telephone numbers and frequently called telephone numbers;
a help button located on the front panel surface that is manually pressed to guide users through the operational functions of the computerized phone book;
a light control button located on the front panel surface that is manually pressed for lighting the LCD display screen;
a disc drive slot extending into the housing and into which a disc can be inserted for updating the computerized phone book;
a disc drive contained within the housing and interconnected to the disc drive slot so that information can be transferred from the disc for updating the computerized phone book;
a cpu interconnected to and controlling the operations of the LCD display screen, the keyboard, the resident button, the business button, the emergency button, the list button, the help button, the light control button, and the disc drive; and
a main memory storage interconnected to the cpu for storage therein of the telephone numbers.

7. The computerized phone book of claim 6 wherein the main memory storage is further partitioned into a main telephone number storage compartment, a frequent/favorite telephone storage compartment, and an emergency number storage compartment.

8. The computerized phone book of claim 6 further comprising a power on/off button for turning the computerized phone book on and off.
